(19) United States
(12) Patent Application Publication
(10) Pub. No.: US 2002/0026433 A1
(43) Pub. Date: Feb. 28, 2002

(54) Knowledge system and methods of business alerting and business analysis

(76) Inventor: Wilko Juurt Jan Kuiper, Bedum (NL)

Correspondence Address: MICHAELSON AND WALLACE, PARKWAY 109 OFFICE CENTER, 328 NEWMAN SPRINGS RD, P O BOX 8489, RED BANK, NJ, 07701

(21) Appl. No.: 09/827,068

(22) Filed: Apr. 5, 2001

Related U.S. Application Data
(60) Provisional application No. 60/194,360, filed on Apr. 5, 2000.

(30) Foreign Application Priority Data
Apr. 5, 2000 (EP) 00201227.6

(51) Int. Cl. G06N 5/00; G06F 17/00

(52) U.S. Cl. 706/45; 707/100; 705/7

(57) ABSTRACT

A knowledge system compiled on a computer environment or a memory carrier is disclosed The knowledge system couples information about one or more business processes or functions to one or more software and hardware components stored in the computer environment. The knowledge system provides information about the impact on business processes or functions towards a user interface in case of an erroneous operation of the software and hardware components.

### FIELD OF THE INVENTION

The present invention relates to knowledge or expert systems and to methods of business processing. More in particular a novel computer knowledge system and novel methods of business processing making use of knowledge relations are disclosed.

### BACKGROUND OF THE INVENTION

Knowledge or expert systems are known in the art. An example of such a system is the Service Assurance Center system, commercially provided by the company BMC Software, the publicly available information about this system being incorporated herein by reference, The Service Assurance Center provides Information Technology organizations a view of:

how services are performing;

whether services are available at any given moment around the world; and

how both its internal staff and external customers are using its application services.

The Service Assurance Center system is monitoring Information Technology (IT) systems, including software application parts, and the technical Infra Structure (IS), including hardware components. This monitoring is executed by synthetic transactions wherein, for example, a Personal Computer emulates the behavior of a user. Hereby information can be gathered whether and to what extent parts of the IT systems are correctly working or are correctly emulating a physical infrastructure.

In an article by Lewis, L, et al., “Incorporating Business Process Management into Network and Systems Management”, Proceedings-ISADS 97-Third International Symposium on Autonomous Decentralized Systems (Cat. No. 97TB100111), Proceedings of the International Symposium on Autonomous Decentralized Systems, ISADS 97, Los Alamitos, Calif., USA, IEEE Comput. Soc. Press, USA, page(s) 385-392, an approach towards autonomous, decentralized monitoring and management of Business Processes (BP) is disclosed.

To realize BP management, existing techniques in integrated network and systems management are employed. The system is made up of agents, among others an alarm monitoring agent, who's responsibility is to collect and forward alarms of the operation of hardware and software components used in a computer environment operative for enabling a plurality of business processes, a reasoning agent for correlating alarms, and an alarm notification agent displaying alarms concerning BP to users, for taking corrective actions manually or automatically.

The system disclosed correlates business processes or functions to changes or disturbances in the IT system, i.e. the software components, as well as to the IS system parts, i.e. the hardware components, making up the computer environment.

### PROBLEM DEFINITION AND AIM OF THE INVENTION

The prior art knowledge or expert systems disclosed above just provide a tool for controlling and/or managing the IT/IS systems being part of a business and for correlating business processes or functions to changes or disturbances in the IT/IS system.

In practice, business processes or functions are associated with one another, such that malfunctioning of one or a few of the business processes, for example, can have a tremendous impact on the operation or execution of other business processes or functions, either directly or indirectly enabled by the computer environment.

In a telecommunications network, for example, failure of a switch may not only involve the call processing of that particular switch, but also payment transactions and other vital data transactions, on a local or even global scale.

There is a further problem in the art in that the IT/IS systems that are developed to manage or monitor the business processes or functions are becoming more and more complex. Therefore it is difficult to analyze the impact of functional errors in parts of the IT/IS systems in relation to the performance of the system as a whole. Prior art solutions do not tackle this problem to a sufficient level.

Accordingly, there is a need to provide a knowledge system that not only communicates about a single or a few business processes in terms of its or their relation to the performance of the underlying IT/IS system, but also on how the operation of affected business processes influence the operation or execution of other business processes of the computer system.

### SUMMARY OF THE INVENTION

In accordance with a first aspect of the present invention, there is provided a computer knowledge system, for operation in a computer environment using a plurality of hardware and software components operatively arranged for enabling a plurality of business processes, the computer knowledge system comprises:

a monitoring agent, arranged for collecting data providing information about the operation of the hardware and software components;

a relational database, storing data providing information about the operation of the business processes and error data relating to erroneous operation of the hardware and software components; and

a user interface, arranged for providing information about the operation of the business processes using the data collected by the monitoring agent and the data stored in the relational database,

the relational database being arranged for providing information towards the user interface about the impact on the operation of the business processes of an erroneous operation of the hardware and software components.

The knowledge system according to the present invention couples information about one or more business processes or functions to one or more software and hardware components used in the computer environment, while the knowledge system provides information about the impact on the execution of business processes or functions towards a user interface in case of erroneous operation of the software and hardware components.

The software and hardware components can include all kind of Information Technology infrastructures known to the person of skill in the art, including network connections, files, database, and software applications. The software components furthermore can be coupled to the physical infrastructure on which the business processes or functions are based.

The business processes or functions may include, for example, a business process communication, such as a fixed-telephone telecommunication connection, and may include the IT system including the operating system and IS hardware of the business process and the network connections of the telephone network.

In the case of a the above telecommunications system, for example, with the present invention, failure of a switch will not only be reported as to affecting the call processing of that switch but also as to the impact thereof to other business processes, such as the financial transactions handled through this switch.

Thus, the business processes or functions information provided by the present invention are broader than setting up a one-to-one connection between an error identification in a software component and a corresponding troubleshooting message to a user interface, while the information is provided in the “language” of the business processes.

The business process or functions, for example, can also include financial processes such as investment funds management or financial transaction business processes or production installation processes such as the actual production processes in a chemical plant or for car manufacturing. The business processes or functions are automated an preferably integrated business processes or functions with a complexity of individual business steps that are related one to the other.

In a further embodiment of the computer knowledge system according to the present invention, the relational database comprises data identifying functional transactions within the business processes and dependencies between functional transactions of the business processes, wherein the user interface is arranged for correlating the error data and the functional transactions data for providing the information about the impact on the business processes of an erroneous operation of the hardware and software components.

The coupling of information about one or more business processes or functions to one or more software and hardware components can be done in several ways. The coupling can include a correlation between one or more business processes or functions to one or more software components and/or include a straightforward link with a number of call-in procedures between one or more business processes or functions to one or more software and hardware components. At least part of the coupled information can be stored in the relational database or stored on the computer environment. The relational database for example can be based on ACCESS, or can be based on database software provided by ORACLE, SYBASE, or SEQUEL SERVER or any other relational database software known to the person of skill in the art.

A main purpose of the computer knowledge system according to the present invention is a goal-oriented processes control. To this end, in a yet further embodiment of the system according to the invention, the user interface is arranged for providing the information about the business processes indicating at least one of a group comprising:

the extent to which business processes are influenced by a disturbance in the software and hardware components;

the extent to which business processes are influenced by a functional error in the hardware and software components;

the extent to which business processes are influenced by a functional error in the hardware and software components, which functional error cannot directly be monitored;

the extent to which business processes are influenced by an externally applied change, such as a predetermined change for performing impact analyses in the hardware and software components; and

the extent to which business processes are available in the case of an erroneous operation of the hardware and software components.

The information provided can benefit from historical data about erroneous operation of the hardware and software components. To this end, in accordance with an other embodiment of the computer knowledge system of the invention, the system comprises a historical database, storing historical data about erroneous operation of the hardware and software components and the impact thereof on the business processes, wherein the user interface is arranged for providing the information about the impact on the business processes of an erroneous operation of the hardware and software components using the historical data.

Business process monitoring and business process control generally involves several user groups, both internally and externally of the computer environment on which the business processes are internally or externally executed. The several user groups have different requirements as to the type and presentation of the relevant information.

Accordingly, in a still further embodiment of the computer knowledge system according to the present invention, the user interface is arranged for providing the information about the impact on the enabling of the business processes of an erroneous operation of the hardware and software components in a predetermined format adapted to the user of the information. In a more detailed embodiment, the computer knowledge system according to the present invention is arranged for providing the information relevant to the different user groups in terms of:

functionality of the business processes;

usability of the business processes;

maintainability of the business processes;

efficiency of the business processes;

reliability of the business processes; and

changeability of the business processes.

The coupling of information about one or more business processes or functions to one or more software and hardware components can be done in several ways. The coupling can include a correlation between one or more business processes or functions to one or more software components and or may include a straightforward link with a number of call-in procedures between one or more business processes or functions to one or more software and hardware components. At least part of the coupled information can be stored in the relational database which stored on said computer environment.

In a further embodiment of the system according to the invention, the monitoring agent, the relational database and the user interface connect through a central agent, among orders, providing processing support.

The user interface can be part of the computer environment, but the user interface can also be external to the computer environment and be linked by a communication channel to the knowledge system. The user interface can be a computer screen, a mobile telephone or a flat panel or whatever user interface suitable for the purpose of the present invention and known to the person of skill in the art. The user interface can also include the World-Wide-Web internet or intranet infrastructure.

The information to be collected about the operation of the hardware and software components, is in a further embodiment of the invention, acquired in that the monitoring agent is arranged for collecting:

workflow data provided by the computer environment;

system monitoring data; and

data accumulated in a data warehouse of the computer environment.

Data accumulated in a data warehouse will, in general, have a low topicality. Workflow data are acquired using an automated Workflow Management System (WMS) or ERP system or systems. System monitoring data is collected on-line from the infrastructure or derived from IT application and system monitoring.

In a preferred embodiment of the invention, the monitoring agent comprises a knowledge module, operating with a business flow monitor and a component monitor for collecting data providing information about the operation of the business processes and the hardware and software components.

The knowledged module, in a yet further embodiment of the computer knowledge system of the invention, is arranged for collecting data with respect to:

availability of critical components;

communications performance between critical components;

critical messages in application and system log files;

synthetic transaction from end user view;

application and system processes;

database and critical table(s) data availability; and

system resource availability and performance.

The user interface may be arranged for providing information on an automated basis or on a subscription basis, for example by issuing notification messages, standard reports, as an HTML (Hyper Text Markup Language) page and in a form of a trouble ticket. Further, in accordance with the present invention, the information towards the user interface, in order to reduce the information flow, may be provided if the impact on the execution of the business processes exceeds a predeterminated threshold value.

In a second aspect of the present invention, a method of providing information or alerting about the operation of business processes in a computer environment using a plurality of hardware and software components operatively arranged for enabling a plurality of business processes, the method comprises:

collecting data providing information about the operation of the hardware and software components;

storing data providing information about the operation of the business processes and error data relating to erroneous operation of the hardware and software components; and

providing information towards a user interface about the operation of the business processes using the collected and stored data,

the data are processed for providing information towards the user interface about the impact on the enabling of the business processes of an erroneous operation of the hardware and software components.

In a third aspect of the present invention, there is provided a method of analyzing the operation of business processes in a computer environment using a plurality of hardware and software components operatively arranged for enabling a plurality of business processes, the method comprises:

collecting data providing information about the operation of the hardware and software components;

storing data providing information about the operation of the business processes and error data relating to erroneous operation of the hardware and software components; and

providing information towards a user interface about the operation of the business processes using the collected and stored data,

the data are processed for providing information towards the user interface about the impact on the enabling of the business processes of an erroneous operation of the hardware and software components.

In a fourth aspect, the present invention provides a computer program stored on a computer readable medium, as well as a such a computer readable medium, for use with a computer knowledge system and methods of business information, alerting and analyses as disclosed above.

The computer readable medium can be a floppy disk, a CD-rom, Digital Video Disk (DVD) or other memory or data carrier known to the skilled person. A number of terms used throughout this description are further detailed here below in order to complement the understanding of the person of skill in the art of these terms.

A knowledge system can also be defined as an expert system. An error in the IT/IS components can include changes of whatever nature including disfunctioning or disturbances of the software components.

### BRIEF DESCRIPTION OF THE DRAWINGS

FIGS. 1a and 1b schematically show the architecture of an example embodiment of a knowledge system of the present invention, including additional software components.

FIG. 2a shows an embodiment of the infrastructure of an example business process of fixed-telephone connections.

FIG. 2b shows a number of operations being part of a business process.

FIG. 3 shows an embodiment of a user interface showing geographic information about a business process.

FIG. 4 schematically shows dependencies within the functionality of the NERVECENTER knowledge system according to a best mode embodiment of the invention.

### DETAILED DESCRIPTION OF THE INVENTION

For the purpose of teaching of the invention, a preferred embodiment of a knowledge system and methods of the invention are described in the sequel. It will be appreciated by the person skilled in the art that other alternative and equivalent embodiments of the invention can be conceived and reduced to practice without departing form the true spirit of the invention, the scope of the invention being limited only by the appended claims.

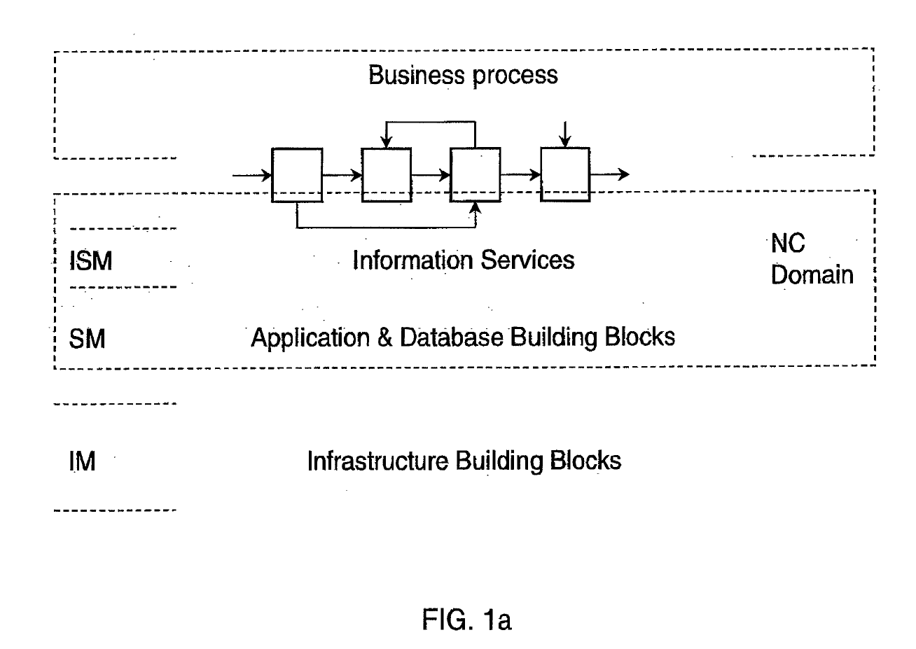

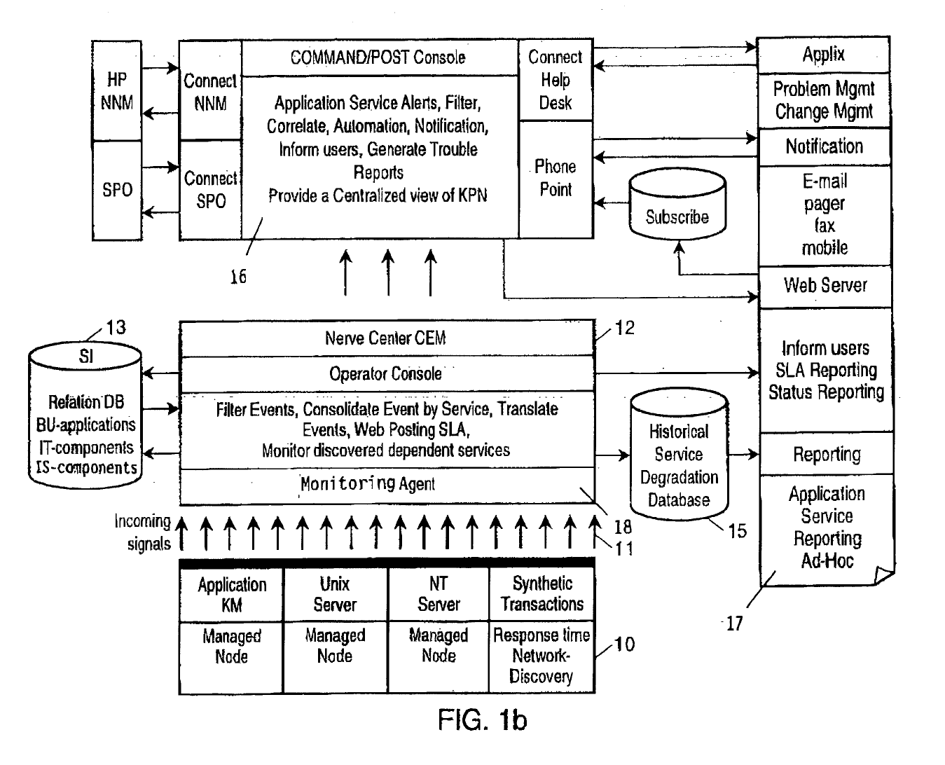

FIG. 1a schematically shows the architecture of an example embodiment of a knowledge system of the present invention.

In the upper part of the figure, several business processes are shown. The business processes or functions, for example, may include financial processes, financial transaction business processes, production installation processes, telecommunication processes, etc.

As can be clearly viewed from the figure, the business processes or functions have several interdependencies, indicated by the arrowlinks between the business processes. An erroneous operation of one or a plurality of the business processes will have an impact on the operation or execution of another or a plurality of other business processes.

The business processes are enabled by Information Technology (IT) components or building blocks, in the present application also indicated by the term software components, and InfraStructure (IS) components or building blocks, in the contekst of the present patent application generally called hardware components. The IS/IT building blocks form part of a computer environment enabling the business processes. In FIG. 1a the IS/IT building blocks are shown in the lower part of the figure. The knowledge system of the present invention is depicted in the middle of FIG. 1a. The knowledge system comprises two main parts, an Information Services (IS) part and an Application & Database Building Blocks part. FIG. 1b schematically shows the architecture of an example embodiment of a knowledge system of the present invention, including additional software components.

The knowledge system of the invention includes the part SI which is a relational database 13 that includes the information about the coupling or the relations between the software and hardware (IS/IT) components and the business processes or functions.

Incoming signals 11 from the IS/IT components 10 are fed to a central agent 12 including a monitoring agent (PATROL) 18. The signals may include the signaling of a change or a disturbance or an error in the software components, The central agent 12 may include functionality on filtering of the incoming signals. The signals from the central agent 12 thereafter are fed to the relational database 13, However, the signals can also be fed directly to the relational database 13.

In the relational database, links are available and made between the software and hardware components 10 and the corresponding business processes or functions. Links are then automatically generated via the central agent 12 to user interfaces 16-17 and a database 15 that stores the occurrence of incoming signals, also called the historical service degradation database 15.

A signal that is generated towards the user interfaces 16-17 and the historical service degradation database 15 is popping up on the user interface. From the user interface several reports can be drawn on the impact of the business processes affected by the signaling due to a change or disturbance or error in the software and hardware components, among others using the contents of the historical database.

Further functionality can be included in the knowledge system by smoothly integrating new software components and interfacing to other knowledge systems or other computer environments.

In the development of the relational database 13, there are a number of steps that can be followed. A first step includes the analysis of the business flow and the analysis of the IS components that support the business process flow. This step includes the identification of functional transactions within the business process, the documentation of possible errors and known failure points, and of known problems within the business transaction flow and the IT/IS components. A next step may include the definition of the relationship and dependencies between the individual business steps or transactions within the, process, and the dependencies between the individual business steps or transactions within the process and software components of the IT infrastructure supporting the business process on the other hand.

The mapping of the business and IT/IS infrastructure includes the definition of the correlation of the impact of the IT/IS infrastructure events on the business process flow. Furthermore can be provided a definition of threshold alarm levels and alerts and the definition of data presentation formats and reporting formats, which can be made user dependent, on a subscription bases or automatically. The results of these steps are stored as dependencies in the relational database and as links to separate software and hardware components and as separate software components. There can be provided further a software application that monitors the business process flow and an application that monitors the software components. The further functionality of links to a user interface and other functionalities of the knowledge system are to be provided.

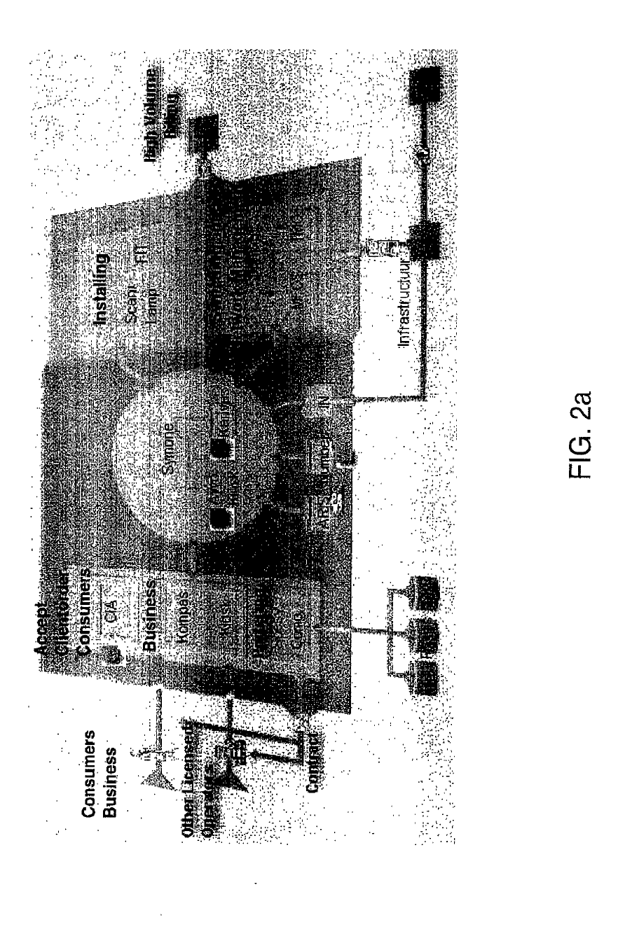

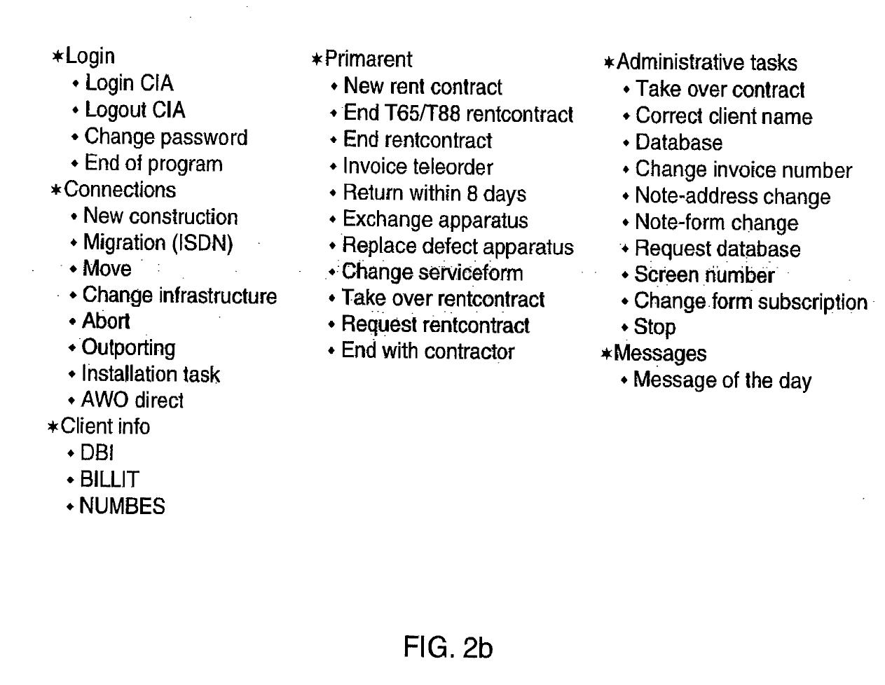

FIG. 2a shows an embodiment of the infrastructure of an example business process of fixed-telephone connections. FIG. 2b indicates a number of operations being part of the business process.

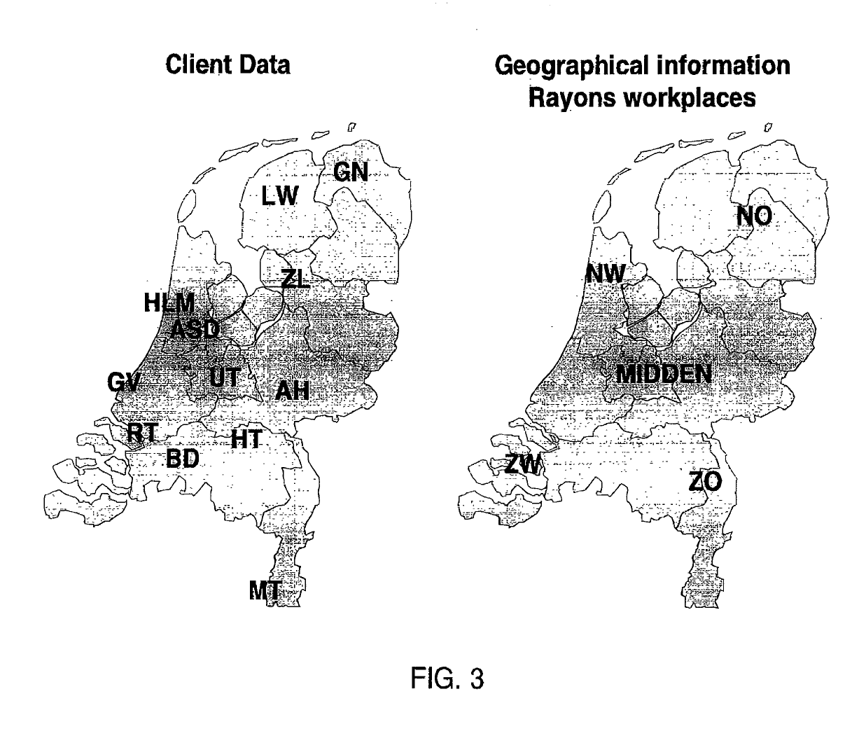

FIG. 3 shows, according to a best mode embodiment of the invention, a user interface showing geographic information about the business process. The business process, as stated above, is one of business processes involved with fixed-telephone connections. One of the parts of this system is the CIA (Client Order Entrance Application) module.

This CIA is interfacing for the entrance of client orders from the consumer market. The CIA is the first part of a chain of software components that link the client order ultimately to the switch connection orders in the telephone central units. The client orders are registered on line. The CIA has interfaces to software components shown in FIG. 2a including modules with client data, infrastructure data, telephone number data, rent data and billing data.

For example the module KANVAS provides to the CIA information about the technical infrastructure such as cables, connections etc. CIA provides to KANVAS the changes that are needed in the technical infrastructure for performing the client order. NUMBES for example contains a database of telephone numbers. If a new number is generated and added to the database, an operator connection is made. The CIA is a 16-bit application and can run under a WINDOWS environment on a PC such as a Fujitsu PC or a DELL PC or any similar PC known to the person of skill in the art. The CIA only contains configuration files; data are stored in the other software components. The different interfaces are based on RPC (T-AAK). The performance of the KANVAS systems is monitored with SYSTAR software. Performance problems of KANVAS lead to a stacking of transactions in the CIA. In order to cope with such problems a knowledge system of the invention such as the NERVECENTER (NC) software shell is to be implemented in order to provide incident control, problem control, change control, configuration management and service level management.

The dependencies in the business process of fixed-telephone connections are analyzed up to the level of the software and hardware components that constitute or monitor the technical process of fixed-telephone connections. These dependencies are stored in a relational database. Scripts are coupled hereto and these scripts generate WebPages.

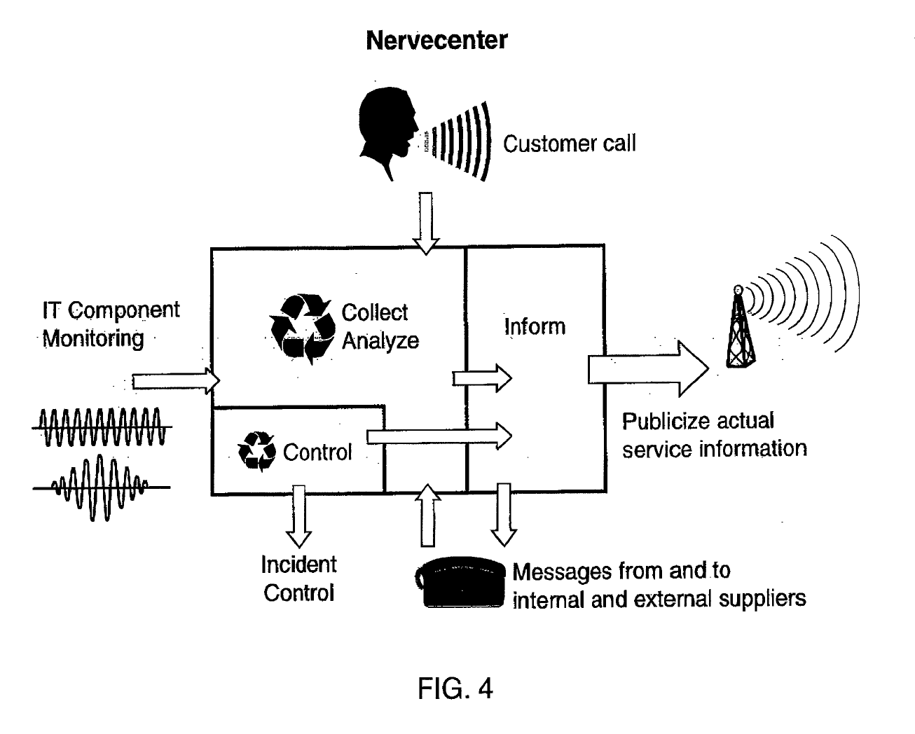

FIG. 4 schematically shows dependencies within the functionality of the NERVECENTER knowledge system according to the best mode embodiment of the invention. A prototype software in an ACCESS database is reduced to practice.

An example of the add-on of the NERVECENTER software to business process of fixed-telephone connections is shown in FIGS. 2b and 3. The geographic extension of the fixed-telephone connections over the Netherlands is shown. The non-availability of parts of the network in different parts of the Netherlands is, in a practical embodiment, indicated by red lights on the map of FIG. 3. The business steps or operations of the list of FIG. 2b that can not be executed, are indicated in red as well. These signals on the user interface are generated through error functions in the software components such as the KANVAS component.

A detailed description of the best made embodiment of the NERVECENTER software is given here below.

1. A computer knowledge system, for operation in a computer environment using a plurality of hardware and software components operatively arranged for enabling a plurality of business processes, said computer knowledge system comprises:
a monitoring agent, arranged for collecting data providing information about the operation of said hardware and software components;
a relational database, storing data providing information about the operation of said business processes and error data relating to erroneous operation of said hardware and software components; and
a user interface, arranged for providing information about the operation of said business processes using said data collected by said monitoring agent and said data stored in said relational database,
said relational database being arranged for providing information towards said user interface about the impact on the operation of said business processes of an erroneous operation of said hardware and software components.

2. A computer knowledge system according to claim 1, wherein said relational database comprises data identifying functional transactions within said business processes and dependencies between functional transactions of said business processes, wherein said user interface is arranged for correlating said error data and said functional transactions data for providing said information about the impact on said business processes of an erroneous operation of said hardware and software components.

3. A computer knowledge system according to claim 2, wherein said user interface is arranged for providing said information about said business processes indicating at least one of a group comprising:
the extent to which business processes are influenced by a disturbance in said software and hardware components;
the extent to which business processes are influenced by a functional error in said hardware and software components;
the extent to which business processes are influenced by a functional error in said hardware and software components; which functional error cannot directly be monitored;
the extent to which business processes are influenced by an externally applied change, such as a predetermined change for performing impact analyses, in said hardware and software components; and
the extent to which business processes are available in the case of an erroneous operation of said hardware and software components.

4. A computer knowledge system according to claim 1, further comprising a historical database, storing historical data about erroneous operation of said hardware and software components and the impact thereof on said business processes, wherein said user interface is arranged for providing said information about the impact on said business processes of an erroneous operation of said hardware and software components using said historical data.

5. A computer knowledge system according to claim 1, wherein said user interface is arranged for providing said information about the impact on the operation of said business processes of an erroneous operation of said hardware and software components in a predetermined format adapted to the user of said information.

6. A computer knowledge system according to claim 1, wherein said user interface is arranged for providing said information about the impact on said business processes of an erroneous operation of said hardware and software components in terms of its impact on at least one of a group comprising:
functionality of the business processes;
usability of the business processes;
maintainability of the business processes;
efficiency of the business processes;
reliability of the business processes; and
changeability of the business processes.

7. A computer knowledge system according to claim 1, wherein said monitoring agent, said relational database and said user interface connect through a central agent.

8. A computer knowledge system according to claim 1, wherein said monitoring agent is arranged for collecting information about the operation of said hardware and software components using at least one of a group comprising:
workflow data provided by said computer environment;
system monitoring data; and
data accumulated in a data warehouse of said computer environment.

9. A computer knowledge system according to claim 8, wherein said monitoring agent comprises a knowledge module, operating with a business flow monitor and a component monitor for collecting data providing information about the operation of said business processes and said hardware and software components.

10. A computer knowledge system according to claim 9, wherein said knowledge module is arranged for collecting data with respect to at least one of a group comprising:
availability of critical components;
communications performance between critical components;
critical messages in application and system log files;
synthetic transaction from end user view;
application and system processes;
database and critical table(s) data availability; and
system resource availability and performance.

11. A computer knowledge system according to claim 1, wherein said user interface is arranged for providing said information on an automated basis comprising at least one of a group including:
a notification message;
a standard report;
an HTML page; and
a trouble ticket.

12. A computer knowledge system according to claim 11, wherein said information towards said user interface is provided on a subscription basis.

13. A computer knowledge system according to claim 11, wherein said user interface is at least one of a group comprising:
a computer screen;
a mobile telephone;
a pager;
a fax; and
a panel.

14. A computer knowledge system according to claim 13, wherein said user interface forms part of said computer environment.

15. A computer knowledge system according to claim 11, wherein said information towards said user interface is provided if said impact on the operation of said business processes exceeds a predetermined threshold value.

16. A method of providing information about the operation of business processes in a computer environment using a plurality of hardware and software components operatively arranged for enabling a plurality of business processes, said method comprises:
collecting data providing information about the operation of said hardware and software components;
storing data providing information about the operation of said business processes and error data relating to erroneous operation of said hardware and software components; and
providing information towards a user interface about the operation of said business processes using said collected and stored data,
said data are processed for providing information towards said user interface about the impact on the operation of said business processes of an erroneous operation of said hardware and software components.

17. A method according to claim 16, further comprising identification of functional transactions within said business processes and dependencies between functional transactions of said business processes, and processing said error data in relation to said functional transactions and their dependencies for providing said information about the impact on said business processes of an erroneous operation of said hardware and software components.

18. A method according to claim 16, wherein said information indicates at least one of a group comprising:
the extent to which business processes are influenced by a disturbance in said software and hardware components;
the extent to which business processes are influenced by a functional error in said hardware and software components;
the extent to which business processes are influenced by a functional error in said hardware and software components, which functional error cannot directly be monitored;
the extent to which business processes are influenced by an externally applied change, such as a predetermined change for performing impact analyses, in said hardware and software components; and
the extent to which business processes are available in the case of an erroneous operation of said hardware and software components.

19. A method according to claim 16, further comprising collecting historical data about erroneous operation of said hardware and software components and the impact thereof on said business processes, wherein said information about the impact on said business processes of an erroneous operation of said hardware and software components is provided from processing said historical data.

20. A method according to claim 16, wherein said information about the impact on said business processes of an erroneous operation of said hardware and software components is provided in terms of at least one of a group comprising:
functionality of the business processes;
usability of the business processes;
maintainability of the business processes;
efficiency of the business processes;
reliability of the business processes; and
changeability of the business processes.

21. A method of alerting about business functions or processes, by providing information in accordance with the method of claim 16.

22. A method of analyzing the operation of business processes in a computer environment using a plurality of hardware and software components operatively arranged for enabling a plurality of business processes, said method comprises:
collecting data providing information about the operation of said hardware and software components;
storing data providing information about the operation of said business processes and error data relating to erroneous operation of said hardware and software components; and
providing information towards a user interface about the operation of said business processes using said collected and stored data,
said data are processed for providing information towards said user interface about the impact on the operation of said business processes of an erroneous operation of said hardware and software components.

23. A method according to claim 22, further comprising identification of functional transactions within said business processes and dependencies between functional transactions of said business processes, and processing said error data in relation to said functional transactions and their dependencies for providing said information about the impact on said business processes of an erroneous operation of said hardware and software components.

24. A method according to claim 22, wherein said information indicates at least one of a group comprising:
the extent to which business processes are influenced by a disturbance in said software and hardware components;
the extent to which business processes are influenced by a functional error in said hardware and software components;
the extent to which business processes are influenced by a functional error in said hardware and software components, which functional error cannot directly be monitored;
the extent to which business processes are influenced by an externally applied change, such as a predetermined change for performing impact analyses, In said hardware and software components; and
the extent to which business processes are available in the case of an erroneous operation of said hardware and software components.

25. A method according to claim 22, further comprising collecting historical data about erroneous operation of said hardware and software components and the impact thereof on said business processes, wherein said information about the impact on said business processes of an erroneous operation of said hardware and software components is provided from processing said historical data.

26. A method according to claim 22, wherein said information about the impact on said business processes of an erroneous operation of said hardware and software components is provided in terms of at least one of a group comprising:
functionality of the business processes;
usability of the business processes;
maintainability of the business processes;
efficiency of the business processes;
reliability of the business processes; and
changeability of the business processes.

27. A computer program stored on a computer readable medium for use in a computer environment and arranged for operating in accordance with claim 1, when compiled on said computer environment.

28. A computer readable medium comprising a computer program according to claim 27.
